(19) United States
(12) Patent Application Publication
(10) Pub. No.: US 2005/0222912 A1
(43) Pub. Date: Oct. 6, 2005

(54) System and method of processing commercial transactions through an internet website

(76) Inventor: David E. Chambers, Killingworth, CT (US)

Correspondence Address: QUARLES & BRADY LLP, RENAISSANCE ONE, TWO NORTH CENTRAL AVENUE, PHOENIX, AZ, 85004-2391, US

(21) Appl. No.: 10/813,944

(22) Filed: Mar. 30, 2004

(51) Int. Cl. G06F 17/60

(52) U.S. Cl. 705/26

(57) ABSTRACT

An Internet-based computer system (10) processes commercial transactions. A customer (12) generates a request for quote for goods or services through an Internet website. The request for quote identifies the goods or services with particularity. A group of suppliers (16, 18) are selected to receive the request for quote based on geographical area or predefined grouping. The request for quote is transmitted to the suppliers through electronic mail. One or more of the suppliers generate a return quote in response to the request for quote. The return quote is sent to the customer through electronic mail. The return quote including pricing information. The customer selects the winning supplier. The commercial transactions are maintained on the Internet website and are available for searching and reporting.

### FIELD OF THE INVENTION

The present invention relates in general to commercial transactions and, more particularly, to system and method of processing commercial transactions through an Internet website.

### BACKGROUND OF THE INVENTION

Commercial transactions take a variety of forms and can undergo many different processes. When a person or business needs an article of manufacture or service, the person contacts one or more known sources looking for the item to purchase. Consider the construction business in which a contractor is building a home, commercial space, or public facility. The contractor will typically compile one or more lists of materials and services needed for the new construction or remodeling project. The lists may include items such as electrical supplies, lighting fixtures, heating and air conditioning units, ventilation ductwork, lumber, masonry, roofing, windows, drywall, cabinets, plumbing fixtures and supplies, flooring, and the like.

The contractor usually maintains a list of wholesale distributors and other sources that deal in such goods and services. The contractor may also learn of new sources of building materials from advertisements, trade publications, observing jobsites, and contacts in the trade. When it comes time to estimate the job or to order the materials, the contractor, or his or her assistant, contacts the known distributors or dealers one-by-one and inquires as to price, quality, availability, alternatives, delivery, and warranty. The list of materials is sent to one or more distributors, who in turn review and consider the bill of materials in light of their product lines and inventory. In situations where the contractor is seeking a competitive offering, the distributor puts together a quote with standard terms and conditions. The contractor will likely send out several requests for pricing to known distributors and then compare the returned quotes to make an informed buying decision. In other situations, e.g., where the contractor has an established relationship or understanding with the distributor, the materials may just be shipped based on the bill of materials.

The process of gathering several competitive quotes is time-consuming and subject to errors. Someone has to contact each distributor, convey the bill of materials, compare the returned quotes, and make a decision as to which distributor can best fill the order. The list of distributors is generally limited to known sources and often includes only local wholesale outlets. Each distributor may have its own ordering format or software interface with which the contractor must comply in order to request an offering or quote. When the process becomes rushed, or when the requests are processed by inexperienced help, mistakes can be made in terms of part numbers, availability, and compatibility with the job site requirements. Since the contractor is often contacting each distributor without detailed knowledge of its product lines, the distributor may not have the needed materials in stock, or may not carry the item at all.

On the other hand, if the contractor becomes accustomed to dealing with specific distributors, the contractor may discover, or continue to do business unaware, that he or she has not been receiving the best price. It is common for the distributor to edge the price up, or at least not push the price down, when the contractor's business becomes routine or worse yet taken for granted.

In still other situations, the contractor may be looking for odd-ball or hard-to-find parts. The contractor may need a new motor for an old heating unit. The contractor may spend considerable time contacting every known distributor, and researching new distributors, looking for the hard-to-find motor. The effort may or may not pay off, but will most likely consume considerable time and effort in the process.

A need exists for a system and process of transacting with suppliers to find goods and services in an efficient and cost effective manner.

### SUMMARY OF THE INVENTION

In one embodiment, the present invention is a method of processing commercial transactions through an Internet website comprising the steps of submitting a request for goods or services through an Internet website, selecting suppliers to receive the request based on geographical area or predefined grouping of the suppliers, transmitting the request to the suppliers, communicating a return quote from the suppliers in response to the request, and transmitting the return quote through the Internet website to an originator of the request.

In another embodiment, the present invention is a method of acquiring goods or services through an Internet website comprising the steps of submitting a request for goods or services through an Internet website directed to a group of suppliers, receiving a return quote in response to the request, and selecting at least one of the suppliers from which to acquire the goods or services.

In another embodiment, the present invention is a method of supplying goods or services through an Internet website comprising the steps of receiving a request for goods or services through an Internet website directed to a group of suppliers, communicating a return quote in response to the request to an originator of the request, and being selected as a supplier to supply the goods or services.

In yet another embodiment, the present invention is a method of supporting transactions for goods or services through an Internet website comprising the steps of receiving a request for goods or services through an Internet website, communicating the request to a group of suppliers, and providing for selection of at least one of the group of suppliers to supply the goods or services.

### BRIEF DESCRIPTION OF THE DRAWINGS

FIG. 1 illustrates an Internet-based transaction processing system;

FIG. 2 illustrates the communication network between the customer and suppliers;

FIG. 3 illustrates a webpage for entry of bill of materials;

FIG. 4 illustrates a webpage for search and selection of suppliers;

FIG. 5 illustrates an e-mail alert which is sent to suppliers;

FIG. 6 illustrates an e-mail alert which is sent to the customer; and

FIG. 7 illustrates the method of processing Internet-based commercial transactions.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

Commercial transactions occur on a daily basis. When a customer needs materials, goods, or services, he or she typically wants to have multiple options and will consider those options based on best combination of price, availability, quality, delivery, features, warranty, and overall value. The customer expects value in return for its business. The present Internet-based commercial transaction system as described herein helps the customer find the best overall value for the needed goods and services.

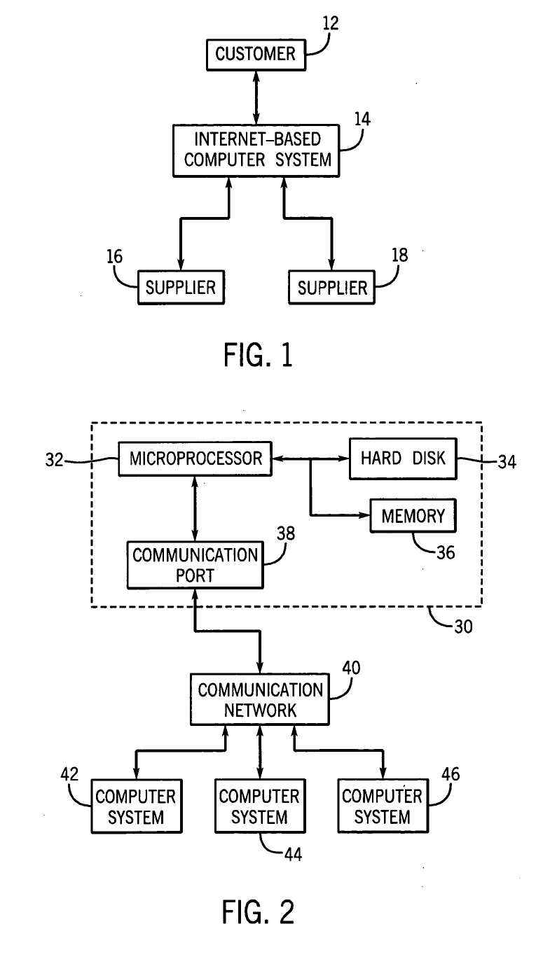

An Internet-based commercial transaction system 10 is shown in FIG. 1. Customer 12 may be a person, contractor, management company, business, government agency, corporation, cooperative, dealer, or retail merchant. Customer 12 has a need for goods, materials, or articles of manufacture. Alternatively, customer 12 may require services, consulting, or contract help. Customer 12 originates a transaction for goods or services through Internet-based computer system 14 in order to reach suppliers 16 and 18. Suppliers 16 and 18 may be wholesale distributors, manufacturers, retail outlets, private parties, or businesses that deal in goods or services. In one embodiment, Internet-based commercial transaction system 10 allows customer 12 to broadcast requests for goods and services to suppliers 16 and 18. Customer 12 does not necessarily, and often does not, know the identity of the potential suppliers. Commercial transaction system 10 helps customer 12, with minimal effort, find suppliers that can fill the order. Those suppliers 16 and 18 that wish to respond with a return quote may do so. Customer 12 receives the responses or returned quotes, considers the options and alternatives, selects one or more suppliers, and completes the transaction with the selected supplier(s).

Although commercial transaction system 10 is applicable to many different transactions and applications, the present discussion assumes that customer 12 is a building construction contractor. Customer 12 builds homes, commercial space, or public facilities. Customer 12 routinely puts together lists of construction materials needed for one or more job sites. The construction materials may include electrical supplies, lighting fixtures, heating and air conditioning units, ventilation ductwork, lumber, masonry, roofing, windows, drywall, cabinets, plumbing fixtures and supplies, flooring, and other construction materials and supplies. The bill of materials (BOM) may be long and detailed, or short and specific. In each case, the BOM represents the essential raw materials needed for the contractor to make progress toward completing the work project on time and within budget. It is important that the BOM be filled by the supplier in a timely, accurate, and cost-effective manner. Paying too much reduces profit and may cause the budget to be exceeded. Mistakes cause time to be wasted in making corrections and may delay the project.

Assume for the present example that customer 12 requires a heating and air conditioning unit and ventilation ductwork. Customer 12 has certain information related to the heating and air conditioning unit and ventilation ductwork, such as general description, part number, electrical ratings, dimensions, thermal capacity, type of material, gauge of material, and installation and mounting requirements, depending on the application and job site. Customer 12 begins the process of locating the needed materials using commercial transaction system 10.

Turning to FIG. 2, further detail of Internet-based computer system 14 is shown. Computer system 30 is provided to host and access an Internet-based website. Computer system 30 is a general purpose computer including a central processing unit or microprocessor 32, mass storage device or hard disk 34, electronic memory 36, and communication port 38. Communication port 38 may be a high-speed Ethernet connection to communication network 40, or a low-speed telephone modem connection. Communication network 40 is an open architecture system such as the World Wide Web, commonly known as the Internet. Computer systems 42, 44, and 46 are configured as shown for computer 30 and are also connected to communication network 40, which allows communication between computers 30 and 42-46.

Computers 30 and 42-46 can be physically located in any location with access to a modem or communication link to network 40. For example, computer 30 can be a central server at a company's home office. Computers 42-46 can be located in any home, company office, contractor office at construction site, or a hotel room, just to name a few.

Computer 30 runs application software and computer programs which can be used to host one or more websites and interact with customer 12 and suppliers 16 and 18. In the present discussion, a commercial transaction website resides on computer 30 and includes one or more webpages for viewing information and for receiving information from customer 12 and suppliers 16 and 18. The commercial transaction website and computer 30 are maintained and operated by a commercial transaction processing company or cooperative. The transaction processing company provides the service to bring customers and suppliers together to solicit, confirm, and complete commercial transactions in an efficient and cost effective manner. The service is fee-based, advertising-supported, or provided as part of cooperative or organization.

Customer 12 accesses the commercial transaction website using computer 42. Suppliers 16 and 18 access the commercial transaction website using computers 44 and 46, respectively. The information displayed on the commercial transaction website is generally stored on hard disk 34, or other mass storage device accessible to computer 30. A database on hard disk 34 stores and maintains the commercial transactions passing through the website. Users operating from computers 42-46 from any location can, via communication network 40, log into the website hosted by computer 30 to view information and enter information via the website.

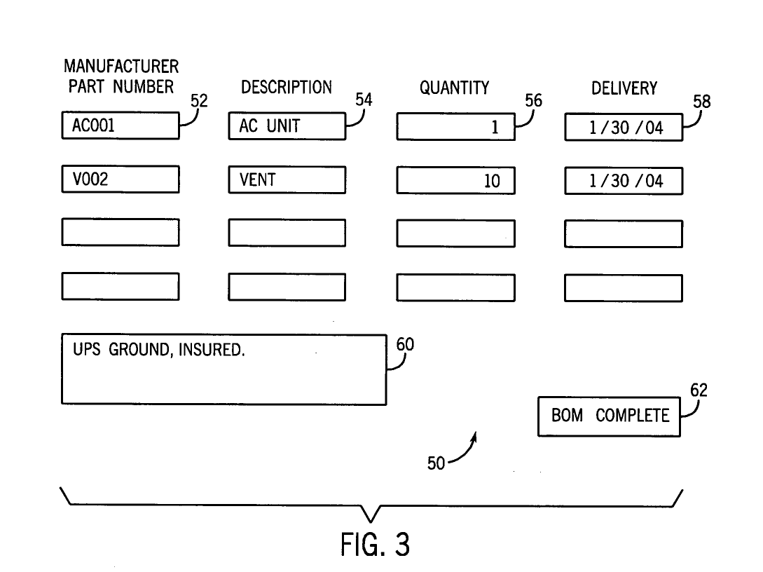

FIGS. 3-6 illustrates a few of the types of selections and information that can be made available on the commercial transaction website. A actual commercial website will include much more in the way of graphics, drawings, text, marketing, color, and appeal. The hierarchical structure of the commercial transaction website is organized by design choice. The organization and design of the website can take many forms. Some website designs pack as much information and as many hyperlinks as possible into the first webpage. Other website designs have a first webpage that is clean and simple and count on the customer providing some preliminary information before moving to lower level webpages.

The operation of the commercial transaction website proceeds as follows: customer 12 uses computer 42 to call up the commercial transaction website residing on computer 30. The home page of the commercial transaction website includes features such as an “About Us” link for describing the commercial transaction processing company; “Tour Page” or “Help” link for guiding the customer or visitor through the process, including a step by step guide to the pricing and product acquisition; “Contact Us” link which provides various phone numbers, business addresses, e-mail addresses, and individual names to send a message or question; and “Sign-up” link for new subscribers.

New customers and suppliers are prompted for information to create a template and to make default selections for the website. The template includes information such as company or individual name, address, contact person, phone numbers, e-mail addresses, license numbers, EPA certification, resale numbers, credit card numbers, primary area(s) of business (electrical, HVAC, plumbing, masonry, irrigation), affiliation with manufacturers, and other business or transaction related information. The template may also include criteria by which the customer or supplier is willing to do business, areas of business or circumstances in which they are or are not willing to participate, payment requirements, shipping requirements, and other similar information. The template is useful in narrowing the field of inquiries and avoid wasting time on both sides with meaningless requests and disinterested responses. After completing the template and reading the terms and conditions of membership, the member clicks on the “Accept” button and the website returns to the home page.

At this point, the new member normally exits the website and awaits confirmation of membership. The membership application is validated by the commercial transaction processing company as to the identity of the applicant and checked to see if the template is properly filled out. The credit card information is confirmed with the bank. Once the applicant has been successfully processed, a confirmation e-mail is sent to the new member and the account is activated. The new member's information is stored in the database on hard disk 34, which is maintained by the website administrator and remains accessible for transactions and administrative purposes.

Once the membership and password are verified and issued, the member can fully utilize the commercial transaction website on Internet-based computer system 14. The member begins by entering the account name and password on the log-in webpage. The commercial transaction website may have selections for high-speed access and low-speed access. The high-speed access provides more in the way of graphics and user-friendly features. The low speed website has more text and fewer graphics, but operates much faster for low-speed telephone modem connections.

From the log-in webpage, the member is then taken to the home or welcome webpage. The home webpage allows the member to select either a customer template or supplier template, which is retrieved from the website database. The home page may provide a “Help” button or pull-down menu selection that has help topics explaining in detail how to operate and utilize the website. The home page may also provide a “Links” button or pull-down menu selection to participating supplier's websites. The “Links” pull-down menu may provide the supplier's names, addresses, contact information, and types of business. The home page may provide an “Access Your Profile” button or pull-down menu selection to allow the member to edit his/her profile, i.e., to change e-mail address, contact name, credit card information, etc.

If the member is customer 12, then the customer is taken to a customer webpage and given a “Request for Quote” button or pull-down menu selection and a “Returned Quotes” button or pull-down menu selection. The “Help”, “Links”, and “Access Your Profile” pull-down menus may also be provided on the customer webpage and other webpages throughout the commercial transaction website.

When customer 12 selects the “Request for Quote” button, a BOM entry screen or webpage 50, such as shown in FIG. 3, is displayed on computer 42 for the customer to enter the BOM and related information. The request for quote can be for pricing or availability. The BOM includes information such as manufacturer and/or part number, description, quantity, and delivery date. From a specific list of materials needed for a jobsite, or at least a general description of materials, customer 12 enters the BOM on webpage 50. The manufacturer and/or part number is entered into box 52, part description is entered into box 54, quantity is entered into box 56, and delivery date and special delivery instructions are entered in box 58. In the present example, the heating and air conditioning unit and ventilation ductwork are entered in the first and second lines or rows of boxes 52-58. Additional BOM entry boxes, or additional BOM screens, allows customer 12 to enter any number of items. The BOM data entry screen is configurable by the type of materials being requested. For example, HVAC equipment may have different ordering requirements and specifications than say finished wood products or electrical supplies and, accordingly, would be given different data entry boxes. Customer 12 can also enter comments in box 60.

In an alternate embodiment, or as an additional feature, the “Request for Quote” button may open an editor page. Customer 12 enters a general description of the item in the editor page. The editor page presents known part numbers matching that description. Customer 12 then selects the desired part number by clicking on the displayed item or by using a pull-down screen. Customer 12 can build the BOM page by selecting items from the general descriptions. The editor page removes the requirement for customer 12 to know the precise part numbers and simplifies the user interface. The selected part numbers are posted on the BOM page.

In another embodiment, customer 12 is able to select any item on the BOM screen and see a purchase history ledger of that item, including a description of the item, brand name, chronological listing of prior purchases of the item, quantity purchased, amount paid, and date of purchase. When the BOM entry screen is complete, customer 12 clicks “BOM Complete” button 62 and the BOM is saved in the commercial transaction database. The present BOM from customer 12 is assigned a unique reference identifier for the request for quote transmittals and for ready accessibility for other transactions and administrative purposes.

In yet another embodiment, the BOM is created locally on computer 42. Computer 42 may or may not be connected to communication network 40 at the time of creation of the BOM. Customer 12 can work on the BOM off-line, i.e. at a location without Internet connection. Each BOM is stored locally until such time as computer 42 reestablishes a link to communication network 40. The BOM(s) are then transmitted to computer 30 over communication network 40.

Once the BOM is complete, a request for quote transmission is sent to suppliers who may be able to fill the BOM order. The commercial transaction website maintains a listing of suppliers and their type of business and the type of products which they have available or may be able to get. The operator of the commercial transaction website maintains up-to-date information on the suppliers, and adds new suppliers and removes other suppliers from time-to-time.

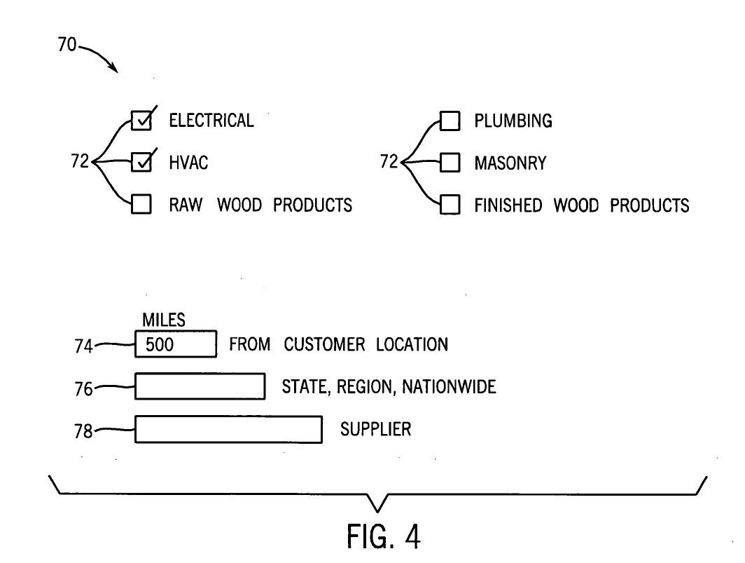

Customer 12 is taken to supplier selection webpage 70 as shown in FIG. 4. Commercial transaction system 10 relieves customer 12 of the burden of having to know and maintain a supplier base. Instead, supplier selection webpage 70 allows customer 12 to direct the BOM request for quote to a general geographical area, or group suppliers, without necessarily, and often not, knowing the identity of the potential suppliers in that area. Customer 12 may designate generally the type of suppliers to which the BOM request for quote is to be sent by selecting the check-boxes adjacent to the desired type of suppliers. Webpage 70 shows supplier types of electrical, plumbing, heating ventilation air conditioning (HVAC), masonry, raw wood products, and finish wood products. Customer 12 checks one or more of boxes 72 to select the type(s) of suppliers to which the BOM request for quote will be sent. Customer 12 may enter a distance measure, say 500 miles, from their home location or zip code in box 74, or a given geographical area, e.g., specific state, region, or nationwide, in box 76. Alternatively, customer 12 selects one or more suppliers by association or from a predefined group of preferred suppliers in box 78. Customer 12 or the operator of the website may have defined different groups of suppliers from prior experience. One group of suppliers may have a better track record in one situation, e.g. large inventory with many items in stock, and another group of suppliers may work better in another situation, e.g. best pricing.

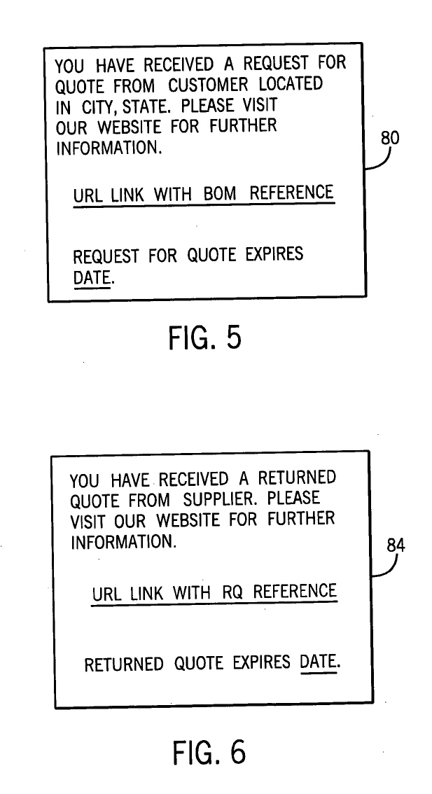

Once the group of suppliers are selected, a notification or alert is sent to each designed supplier to let them know that a BOM request for quote is pending on the commercial transaction website for its consideration. The notification is sent from customer 12 through the commercial transaction website to the selected group of suppliers. The notification is sent by a communication medium which is reasonable to reach the supplier, e.g., e-mail, phone, fax, mail, or posting on a message board. In FIG. 5, e-mail alert 80 provides basic information that the supplier has received a request for quote from a customer located in a specific city and state. Supplier 16 receives the e-mail alert on computer 44; supplier 18 receives the e-mail alert on computer 46. The e-mail alert gives the uniform resource locator (URL) address link with BOM reference identifier to take the supplier to the exact BOM request in the commercial transaction database. The suppliers are invited to respond to the invitation for quotes on the BOM. An expiration date of the request for quote is given.

Note that the notification includes a reference to the BOM, but may not include the identity of customer 12 other than city and state. Withholding identity of customer 12 has certain privacy and business advantages for customer 12 and the operator of the commercial transaction website.

Customer 12 will have the opportunity to amend any outstanding or pending request for quote by calling up the BOM by reference identifier and making the necessary changes. Another e-mail alert is automatically sent to the selected suppliers to notify them of the change.

Assume supplier 16 receives the BOM notification. Supplier 16 clicks on the URL link or logs into the commercial transaction website and calls up the given BOM reference identifier to review the detailed BOM specification. Supplier 16 interacts with the website via computer 44. Supplier 16 checks its own pricing, stock, and considers the delivery date and special delivery instructions, warranty, and customer's comments. The special delivery instructions may be options such as ground delivery, overnight air express, single or multiple deliveries to job site, etc. Supplier 16 compiles a return quote and includes any comments for customer 12. Supplier 16 submits the return quote (RQ) through computer 44 to the commercial transaction website. The return quote is stored in the commercial transaction database. The supplier's return quote is assigned a unique reference identifier for the return quote transmittals and for ready accessibility for other transactions and administrative purposes. Alternatively, supplier 16 may submit the return quote directly to customer 12, if the customer identity is known.

Other selected suppliers like 18 will also have the opportunity to consider the request for quote and provide their own returned quotes back to the commercial transaction website or to customer 12. Supplier 18 receives the BOM request for quote and responds with the return quote by way of computer 46.

Customer 12 receives notifications of returned quote from one or more suppliers. The notification is sent from the suppliers through the commercial transaction website to customer 12, or directly from the supplier to customer 12 if the customer's identity is known. The notification(s) are sent by a communication medium which is reasonable to reach the customer, e.g., e-mail, phone, fax, mail, or posting on a message board. In FIG. 6, e-mail alert 84 provides basic information that the customer has received a returned quote. The e-mail alert gives the URL address link with return quote reference identifier to take the customer to the exact BOM returned quote in the commercial transaction database. An expiration date of the returned quote is given.

Customer 12 clicks on the URL link or logs into the commercial transaction website and calls up the given return quote reference identifier using the “Returned Quotes” button to review the returned quote(s) from the responding suppliers. The returned quotes will include information such as price, availability, responses to the delivery instructions, warranty, insurance, handling charges, expiration date of the quote, internal reference or tracking number, tax exempt status, payment terms, and supplier's comments and special instructions.

In some cases, customer 12 will have the option of selecting certain items from supplier 16 and other items from supplier 18. Customer 12 can thus pick and choose to get the best overall deal. Once customer 12 decides on the winning quote(s), he or she clicks an “Order Material” button or selects a pull-down menu item. The winning supplier(s), e.g., supplier 16, receive notice of award and can return to the commercial transaction website to see the identity of customer 12. The winning supplier 16 may have the option of declining the BOM once the identity of customer 12 is revealed. Customer 12 may have an outstanding balance with supplier 16 or there may be some other issue which makes completion of the transaction impractical or inappropriate. Customer 12 makes arrangements for payment by credit card or charge account with supplier 16. Supplier 16 ships the BOM and customer 12 receives the BOM to complete the commercial transaction. The commercial transaction website operating company may receive a commission or fee for the service provided.

By using the commercial transaction website, customer 12 has reached potentially a large number of suppliers, many of which might be unknown, but all of whom are interested in doing business. Customer 12 finds suppliers for the needed goods and services, with minimal effort and expense, by simply broadcasting the request for quote to selected geographical areas or types of suppliers.

Commercial transaction system 10 has simplified the process of transacting for goods and services and provided several business advantages for the benefit of customers and suppliers alike. Customer 12 need no longer spend considerable time contacting the suppliers one-by-one to shop for price and availability to fill its BOM. Suppliers 16 and 18 have access to customers and business they otherwise may not have had. The commercial transaction website gives customer 12 access to many suppliers. Customer 12 can select local, regional, or nationwide coverage in looking for the BOM and reach many suppliers which were heretofore unknown. Customer 12 can specify suppliers in certain geographic boundaries or only certain types of suppliers to receive the request for quote. Business can be transacted conveniently and efficiently at any hour or day and from any location with Internet access. Customer 12 is no longer required to conform with each individual supplier's software package in order to do online ordering.

The commercial transaction website is multi-dimensional and operates in multiple layers of abstraction. Supplier 16 may be a local distributor and need inventory from a national distributor, or from the manufacturer, in order to fill the BOM for customer 12. In this context of commercial transaction system 10, supplier 16 becomes the customer and the national distributor or manufacturer becomes the supplier. The commercial transaction process proceeds in a similar manner as discussed above. Supplier 16 sends out one or more requests for pricing and its suppliers return quotes using the commercial transaction website. Supplier 16 selects the winning quote and the parties complete the transaction.

In other applications, customer 12 can use the commercial transaction website to locate hard-to-find parts. Customer 12 simply broadcasts the part number or general description of the hard-to-find parts to selected suppliers, inquiring as to price and availability, and awaits the responses. Alternatively, a distributor may use the commercial transaction website to liquidate dead stock, i.e., inventory that has become out-dated or hard to sell, to another distributor. The distributor may have a buyer for a product that is known to be hard to sell and can use that opportunity to acquire more of the product from other distributors through the commercial transaction website.

The commercial transaction website is applicable to other businesses such as services, automotive parts, home improvement, office equipment and supplies, government supply chain and acquisitions, and the like. The services transacted through the commercial transaction website may include such areas as consulting services, employment and temporary help services, and professional services.

The commercial transaction website further provides historical information for the benefit of customer 12 and suppliers 16 and 18. The historical information includes prior requests for pricing, returned quotes, and completed transactions as stored in the commercial transaction database. The historical commercial transaction information is maintained within member filing cabinets in the database in computer 30. The members can manage and make use of the contents of the filing cabinets. The members can search, review, delete, and report on the prior transactions. The reports can show how much has been spent on a particular job, or show how much has been ordered from a particular supplier, or show outstanding requests for pricing, or inquiry why a particular supplier did not respond to a pending request for quote. The member is able to track purchases and jobs and do simple reorders by utilizing the filing cabinet feature. The commercial transaction database will be able to provide data as to where sales are occurring, which is valuable to manufacturers and distributors to understanding market share and trends.

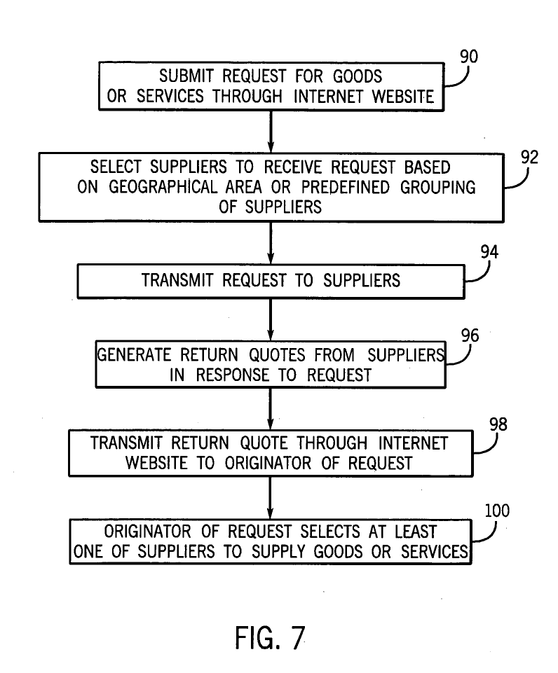

The process of conducting commercial transactions on an Internet website is shown in FIG. 7. Step 90 submits a request for goods or services through an Internet website. The request identifies the goods or services. The website maintains a listing of suppliers. Step 92 selects suppliers to receive the request based on geographical area or predefined grouping of the suppliers. Step 94 transmits the request to the suppliers through electronic mail. Step 96 communicates a return quote from the suppliers in response to the request through electronic mail. The return quote from the suppliers includes pricing information. Step 98 transmits the return quote through the Internet website to an originator of the request. In step 100, the originator of the request selects at least one of the suppliers to supply the goods or services. The commercial transactions are maintained on the Internet website and are available for searching and reporting.

1. A method of processing commercial transactions through an Internet website, comprising:
submitting a request for goods or services through an Internet website;
selecting suppliers to receive the request based on geographical area or predefined grouping of the suppliers;
transmitting the request to the suppliers;
communicating a return quote from the suppliers in response to the request; and
transmitting the return quote through the Internet website to an originator of the request.

2. The method of claim 1, wherein the request identifies the goods or services.

3. The method of claim 1, wherein the Internet website maintains a listing of suppliers.

4. The method of claim 3, wherein the originator designates a geographic area to select suppliers from the listing of suppliers.

5. The method of claim 1, wherein the request is transmitted to the suppliers through electronic mail.

6. The method of claim 1, wherein the return quote from the suppliers including pricing information.

7. The method of claim 1, wherein the return quote is transmitted to the originator through electronic mail.

8. The method of claim 1, further including the step of selecting at least one of the suppliers to supply the goods or services.

9. The method of claim 1, wherein the commercial transactions are maintained on the Internet website.

10. The method of claim 9, wherein the commercial transactions are available for searching and reporting.

11. A method of acquiring goods or services through an Internet website, comprising:
submitting a request for goods or services through an Internet website directed to a group of suppliers;
receiving a return quote in response to the request; and
selecting at least one of the suppliers from which to acquire the goods or services.

12. The method of claim 11, wherein the Internet website maintains a listing of suppliers.

13. The method of claim 11, wherein an originator of the request designates a geographic area to select the group of suppliers from the listing of suppliers.

14. The method of claim 11, wherein the request identifies the goods or services.

15. The method of claim 11, wherein the request is transmitted to the group of suppliers through electronic mail.

16. The method of claim 11, wherein the return quote is transmitted to an originator of the request through electronic mail.

17. The method of claim 11, further including the step of maintaining commercial transactions on the Internet website for searching and reporting.

18. A method of supplying goods or services through an Internet website, comprising:
receiving a request for goods or services through an Internet website directed to a group of suppliers;
communicating a return quote in response to the request to an originator of the request; and
being selected as a supplier to supply the goods or services.

19. The method of claim 18, wherein the request identifies the goods or services.

20. The method of claim 18, wherein the request is transmitted to the group of suppliers by electronic mail.

21. The method of claim 18, wherein the return quote is transmitted to an originator of the request by electronic mail.

22. The method of claim 18, further including the step of maintaining commercial transactions on the Internet website for searching and reporting.

23. A method of supporting transactions for goods or services through an Internet website, comprising:
receiving a request for goods or services through an Internet website;
communicating the request to a group of suppliers; and
providing for selection of at least one of the group of suppliers to supply the goods or services.

24. The method of claim 23, further including the step of communicating a return quote from at least one of the group of suppliers to an originator of the request.

25. The method of claim 23, wherein the Internet website maintains a listing of suppliers.

26. The method of claim 23, wherein an originator of the request designates a geographic area to select the group of suppliers from the listing of suppliers.

27. The method of claim 23, wherein the request identifies the goods or services.

28. The method of claim 23, wherein the request is transmitted to the group of suppliers by electronic mail.

29. The method of claim 23, wherein the return quote is transmitted to an originator of the request by electronic mail.

30. The method of claim 23, further including the step of maintaining commercial transactions on the Internet website for searching and reporting.

31. A system of supporting transactions for goods or services through an Internet website, comprising:
means for receiving a request for goods or services through an Internet website;
means for communicating the request to a group of suppliers; and
means for providing for selection of at least one of the group of suppliers to supply the goods or services.

32. The system of claim 31, further including means for communicating a return quote to an originator of the request.

33. The system of claim 31, further including means for designating a geographic area from which to select the group of suppliers.

34. The system of claim 31, further including means for communicating the request to the group of suppliers through electronic mail.

35. The system of claim 31, further including means for communicating the return quote to an originator of the request through electronic mail.

36. The system of claim 31, further including means for maintaining commercial transactions on the Internet website for searching and reporting.
